(19) United States
(12) Patent Application Publication
(10) Pub. No.: US 2025/0055409 A1
(43) Pub. Date: Feb. 13, 2025

(54) INTEGRATED ROOF MODULE AND MODULAR ROOF SYSTEM THEREOF

(71) Applicant: Wall to Wall, LLC, Hayward, CA (US)

(72) Inventors: Amit HALLER, Belmont, CA (US); Lisong ZHOU, Fremont, CA (US); Shai SHACHRUR, Givat Ela (IL); Yaniv COHEN, Givat Ela (IL); Israel Jay KLEIN, Kfar Saba (IL)

(73) Assignee: Wall to Wall, LLC, Hayward, CA (US)

(21) Appl. No.: 18/720,613

(22) PCT Filed: Dec. 15, 2022
(86) PCT No.: PCT/IL2022/051338

§ 371 Date: Jun. 14, 2024

Related U.S. Application Data
(60) Provisional application No. 63/289,871, filed on Dec. 15, 2021.

(51) Int. Cl. H02S 20/25; H02S 40/36

(52) U.S. Cl. CPC H02S 20/25; H02S 40/36

(57) ABSTRACT

A roof module inter-connectable with at least one other like-modules to form a roof of a building, said roof module comprising a structural frame having a first couplable zone and a second couplable zone, said first couplable zone being readily couplable to a respective second couplable zone of a respective like-module, a Photo Voltaic (PV) layer connected to said structural frame at least partially between said couplable zones, a first connection element disposed at said first couplable zone and operatively connected to said PV layer, a second connection element disposed at said second couplable zone and operatively connected to said PV layer, said first connection element being operatively couplable with a respective second connection element of the respective like-module to facilitate an electrical connection between their respective PV layers.

### CROSS-REFERENCE TO RELATED APPLICATIONS

This application is a U.S. National Stage application under 35 USC 371 of International Application No. PCT/IL2022/051338, filed Dec. 15, 2022, which claims the benefit and priority of U.S. Provisional Application No. 63/289,871, filed Dec. 15, 2021. The entire contents of each priority application are incorporated herein by reference.

### FIELD

The presently disclosed subject matter relates to integrated roof modules and a modular roof formed thereof, and more particularly to inter-connectable roof modules with integrated Photo Voltaic (PV) layers, a modular roof formed thereof, and system for distributing electrical energy produced by the PV layers.

### BACKGROUND

Modular construction is a process in which a building is constructed off-site, under controlled plant conditions, using the same materials and designing to the same codes and standards as conventionally built facilities, in a much-reduced time effort. Buildings are produced in “modules” or “parts” that when put together on site, reflect the identical design intent and specifications of the most sophisticated site-built facility without compromise. As such, the roof part of the building must follow a similar design, manufacturing and assembly philosophy hence it should be prefabricated in advance according to modular construction guidelines while incorporating multiple functionalities as part of the roof construct.

For homes and buildings, a roof performs multiple functions, most of which are tied into providing protection from conditions as bright sunshine, rain, snow, sleet, hail, and high winds. In addition, the roof part is typically utilized for the deployment of photovoltaic (PV) arrays for electrical energy production. In most cases, such PV deployments are handled as an add-on design or retrofit. This of course, increases the overall cost of the solution as additional work effort and materials are required. In some cases, delivering energy from an existing roof to the building internal parts for control and supply can further complicate the deployment if no dedicated building shafts or connectivity arrangements or any other supporting infrastructure exists in advance.

In some cases, the roof area is a shared area among multiple apartments within the same building. In this case the PV capabilities of the deployed systems can be shared between the different units however this can become a complex issue both from a property ownership perspective (e.g., apartments with no roof access or with a dedicated roof access) and from a power management perspective (e.g., sharing the PV produced energy following some agreement). These issues are amplified in the case of property structures such as an apartment complex (a group of buildings that contain apartments and are managed by the same company) at which the sharing scenario can involve building-to-building associations (e.g., buildings sharing their energy production capabilities) or managing the property structure as a whole while connecting to national or local electrical grid network.

### SUMMARY

The presently disclosed subject matter relates to an integrated roof module system and method of constructing the same, in which integrated roof module is a fundamental building block for modular building construction and the roof area is built from at least one prefabricated integrated roof module. The roof module itself includes photovoltaic energy production capabilities, and energy aggregation of a number of roof modules can be achieved by the inherent connectivity features between modules by tiling. When a building consists of more than one area, or when several roof areas from multiple buildings are to be managed, a complete energy production system facilitates the energy control and management as a whole while connected to a national or local grid while providing efficient energy utilization.

The roof module, of the presently disclosed subject matter, consists of several layered structures of diverse purposes (e.g., construction support, thermal insulation, etc.) including a solar panel for electrical energy production purposes. The design details of each module are retrieved and calculated from the relevant data representative of the geographical location of the construction site and other digital twin related data of the complete constructed building itself, hence the design is optimized for several aspects of its designated use such as solar energy production, draining etc. The roof module is prefabricated accordingly in advance prior to reaching the construction site. The complete roof construct not only functions as a regular roof but can be connected to an energy control system (for example, via a plug-and-play connecting interface) for energy production, storage, control, and distribution purposes.

According to a first aspect of the presently disclosed subject matter there is provided a roof module inter-connectable with at least one other like-module to form a roof of a building, said roof module comprising: a structural frame having a first couplable zone and a second couplable zone, said first couplable zone being readily couplable to a respective second couplable zone of a respective like-module; a Photo Voltaic (PV) layer connected to said structural frame at least partially between said couplable zones; a first connection element disposed at said first couplable zone and operatively connected to said PV layer; a second connection element disposed at said second couplable zone and operatively connected to said PV layer; said first connection element being operatively couplable with a respective second connection element of the respective like-module to facilitate an electrical connection between their respective PV layers.

The second couplable zone can be readily couplable to a respective first couplable zone of another respective like-module, the second connection element can be operatively couplable with a respective first connection element of said other respective like-module to facilitate an electrical connection between their respective PV layers.

In some examples, the structural frame can comprise a third couplable zone and a fourth couplable zone, whereas the third couplable zone can be readily couplable to a respective fourth couplable zone of one of said at least one like-module and the fourth couplable zone can be readily couplable to a respective third couplable zone of one of said at least one like-module. The roof module can further comprise a third connection element disposed at the third couplable zone and operatively connected to the PV layer, a fourth connection element disposed at the fourth couplable zone and operatively connected to the PV layer, whereas the third connection element can be operatively couplable with a respective fourth connection element of one of said at least one like-module to facilitate an electrical connection between their respective PV layers and the fourth connection element can be operatively couplable with a respective third connection element of one of said at least one like-module to facilitate an electrical connection between their respective PV layers.

In some examples, at least one of the third couplable zone and fourth couplable zone can be disposed laterally with respect to at least one of the first and second couplable zones.

The roof module is prefabricated in a manufacturing unit in advance prior to reaching the construction site, to be inter-connected with one or more like-modules to form a roof, according to the design and dimension requirements on the construction site.

It is to be understood herein for the purposes of the present description (i.e., for all the examples of roof modules described herein) that the like-modules can be similar or identical to the roof module at least at the corresponding couplable zones for liquid sealed coupling with the roof modules. In some examples, one or more of the like-modules can be exactly identical to the roof module (any example of the roof modules described herein) and include all the features thereof. In some examples, one or more of the like-modules may not be exactly identical, and only similar, to the roof module (any example of the roof modules described herein) and may include only some of the features thereof. In some examples, one or more of the like-modules may include only the features of the roof module (any example of the roof modules described herein) related to coupling or inter-connecting therewith in a liquid-sealed manner. In some examples, the like-module can be an anchor module configured for inter-connecting to the roof module in a manner similar to any other like-module and to establish a connection between the roof module and an interior of the building, as described in detail later herein below.

The roof thus formed by the roof modules is configured to perform all the functions, or at least one function, associated with roofs such as but not limited to water insulation, thermal insulation, acoustic insulation, fire insulation, withstanding seismic lateral forces, drainage, and providing protection to an interior of the building from conditions including sunshine, rain, snow, sleet, hail, and/or winds. The roof modules, for this purpose, can further comprise a functional layer associated with the roof including at least one of water insulation, thermal insulation, acoustic insulation, fire insulation, withstanding seismic lateral forces, drainage, and providing protection to an interior of the building from conditions including sunshine, rain, snow, sleet, hail, and/or winds. Also, the roof module is inter-connectable with the respective like-module in a liquid sealable manner to provide the functionality of insulation and protection.

In some examples, the roof module can include a sheathing layer. In some examples, the roof module can include an insulation material layer for water insulation and/or thermal insulation and/or acoustic insulation and/or fire insulation. In some examples, all the functional layers can be implemented as a single layer. In some examples, the functional layers can be implemented as integrated with the PV layer itself. In some examples, the roof module can be encompassed into a protective glass structure.

The roof module can comprise a front surface configured to face an exterior of the building, and opposite back surface configured to face an interior of the building, and a plurality of side surfaces extending between the front and back surfaces. The front surface can be configured to constitute a continuous roof surface with a respective front surface of the respective like-module when the modules are inter-connected to form the roof. A first side surface of the plurality of side surfaces can at least partially include the first couplable zone and a second side surface of the plurality of side surfaces can at least partially include the second couplable zone. In some examples, the first and second surfaces and corresponding couplable zones can extend in directions opposite to each other. In some examples, the first and second surfaces and corresponding couplable zones can extend in directions transverse to each other.

The roof module can have a regular cuboidal shape, and the roof modules can be interconnectable by simply placing the modules one adjacent to other creating surface continuity. In some examples, different shapes/profiles for the roof modules can be used for various purposes. For instance, in order to achieve a tighter and more effectively sealed connection between the roof modules, the side surfaces can be shaped and oriented in such a way so that the roof module is inter-connectable to the respective like-module such that at least a portion of the front surface of the roof module overlaps at least a portion of a respective second surface of the respective like-module in a direction perpendicular to a direction of said inter-connection and/or at least a portion of a respective front surface of the respective like-module overlaps at least a portion of the back surface of the roof module in a direction perpendicular to a direction of said inter-connection when the roof module is inter-connected to the like-modules.

In some examples, at least one of the first side surface and the second surface can have a stepped profile when seen in a cross-section taken along a plane perpendicular to the respective side surface as well as to the first and/or second surface. The stepped profile can be inter-lockable with a respective stepped profile of the respective like-module to provide said inter-connection between the two modules. In some examples, at least one of the first side surface and the second surface has an inclined profile when seen in a cross-section taken along a plane perpendicular to the respective side surface as well as to the first and/or second surface. The inclined profile can be inter-lockable with a respective inclined profile of the respective like-module to provide said inter-connection between the two modules.

Such an orientation and shape of the couplable zone ensures that when the roof module is inter-connected with the respective like-module, wherein the connection elements are concealed by the couplable zones, thereby providing protection to the inter-connections therebetween from external events.

In some examples, the roof module can be configured to be operatively connected for electrical and plumbing connections with an interior of the building through back surface thereof. In other examples, the back surface can be free of electrical or plumbing connections with an interior of the building.

In some examples, at least one of the first and second connection elements can be configured to facilitate establishment of a continuous and sealed plumbing line therethrough, whereas the structural frame can be at least partially hollow to allow said plumbing line to be routed therethrough.

In some examples, at least one of the first and second connection elements can constitute an electrical connector electrically coupled to the PV layer and configured to electrically couple with a respective electrical connector of the respective like-module. The connection elements can be configured such that a mechanical connection between the roof module and the respective like-module causes the electrical coupling between their respective electrical connectors.

According to a second aspect of the presently disclosed subject matter there is provided an anchor module inter-connectable, preferably in a liquid-sealed manner, with at least one roof module according to any example described above with respect to the first aspect of the presently disclosed subject matter. The anchor module can be configured to introduce energy produced by the roof module into an interior of the building, said anchor module comprising: an anchor structural frame having a first anchor couplable zone readily couplable with at least one of said first and second couplable zones of said roof module; and a first anchor connection element disposed at the first anchor couplable zone and operatively couplable with a respective connection element of said roof module. The first anchor couplable zone can be readily couplable with any of said first and second couplable zones of said roof module. Although generally, the anchor modules are small in size and are free of PV layers, but in some examples, the anchor modules can as well include the PV cells or layers. Irrespective of whether the anchor module includes a PV layer or not, the anchor module can be configured to establish electrical and/or plumbing connections with the interior of the building.

In some examples, the first anchor couplable zone can have a stepped profile inter-lockable with a respective stepped profile of said roof module. In some examples, the first anchor couplable zone can have an inclined profile inter-lockable with a respective inclined profile of said roof module. It is to be understood herein that the anchor couplable zones can have any profile whereas the anchor module is inter-connectable to the roof module such that at least a portion of the front surface of the roof module overlaps at least a portion of the anchor module in a direction perpendicular to a direction of said inter-connection or at least a portion of the anchor module overlaps at least a portion of the back surface of the roof module in a direction perpendicular to a direction of said inter-connection. Such an inter-connection improves at least the liquid sealing of the connection.

In some examples, the first anchor connection element can be configured to facilitate establishment of a continuous and sealed plumbing line therethrough, whereas the anchor module can be at least partially hollow to allow said plumbing line to be routed therethrough.

In some examples, the first anchor connection element can constitute an electrical connector configured to electrically couple with a respective electrical connector of the roof module. The electrical connector can be so positioned and oriented that a mechanical connection between the anchor module and the roof module causes the electrical coupling between their respective electrical connectors.

The anchor modules can constitute termination modules for the roof or can also be configured (shaped, sized, designed, etc.) to serve the purpose of filling the gaps between two roof modules. For instance, the anchor modules can be constructed to include second anchor couplable zones opposite, or laterally disposed to the first anchor couplable zones, readily couplable with a respective couplable zone of another roof module. Such an anchor module can further include a second anchor connection element disposed at the second anchor couplable zone and operatively couplable with a respective connection element of that other roof module. One such example of the anchor module can be a T-shaped module.

According to a third aspect of the presently disclosed subject matter there is provided a kit comprising: at least one roof module according to any example described herein with respect to the first aspect; and at least one anchor module according to any example described herein with respect to the second aspect. In some examples, the kit can comprise at least two anchor modules, each according to any example described herein with respect to the second aspect. In some examples, the kit can comprise at least two roof modules, each according to any example described herein with respect to the first aspect; and at least two charge controllers each configured to be operatively coupled to a respective one of the at least two roof modules and configured to control energy production and distribution by the respective roof module; and at least one master charge controller configured to be operatively coupled to each one of the charge controllers and to control exchange of electrical energy between the charge controllers and an external grid.

According to a fourth aspect of the presently disclosed subject matter there is provided a modular roof of a building, said roof comprising: plurality of roof modules, each according to any example described herein with respect to the first aspect, a first roof module and a second roof module of the plurality of roof modules being inter-connected to each other via their respective couplable zones, wherein the first couplable zone of the first roof module is coupled to the second couplable zone of the second roof module, and the first connection element of the first roof module is operatively coupled with the second connection element of the second roof module having established an electrical connection between the respective PV layers of the two modules therethrough.

The modular roof can further comprise at least one anchor module according to any example described herein with respect to the second aspect, inter-connected with at least one of the first and second roof modules, wherein the first anchor couplable zone of the anchor module is coupled with a respective couplable zone of said at least one of the first and second roof modules, and the first anchor connection element of the anchor module is operatively coupled with a respective connection element of said least one of the first and second roof modules having established an electrical connection between the anchor module and said at least one of the first and second roof modules. The anchor module can be operatively coupled with an interior of the building to facilitate electrical and/or plumbing connection therewith.

In some examples, the modular roof can include at least one non-PV roof module comprising couplable zones corresponding to those of the plurality of roof modules, and being free of a PV layer, the at least one non-PV roof module being inter-connected to at least one of the plurality of roof modules.

The presently disclosed matter addresses that a building may have several roof areas and, in some examples, the energy produced by the roof areas is to be shared by several apartments/houses located in that designated building. In such cases, distribution and control of energy produced by the roof PV modules between the houses becomes challenging. The presently disclosed subject matter thus provides, according to a fifth aspect thereof, a solar-electrical energy distribution system comprising: a first Photo Voltaic (PV) sub-system comprising: a first PV array configured for producing electrical energy from solar energy; one or more first energy consuming units configured to consume electrical energy; and a first charge controller configured for controlling energy distribution to the one or more first energy consuming units; a second Photo Voltaic (PV) sub-system comprising: a second PV array configured for producing electrical energy from solar energy; one or more second energy consuming units configured to consume electrical energy; and a second charge controller configured for controlling energy distribution to the one or more second energy consuming units; and a master charge controller operatively coupled to the first and second charge controllers, said master charge controller being configured to exchange electrical energy with each of the first and second charge controllers and to control energy distribution between the first and second charge controllers and an external grid. It is to be understood herein that each of the first and second sub-systems can represent a house having a roof according to any examples described herein.

The first charge controller can be configured for controlling energy distribution based on an amount of energy produced by the first PV array and amount of energy required by the one or more first energy consuming units, and the second charge controller can be configured for controlling energy distribution based on an amount of energy produced by the second PV array and amount of energy required by the one or more second energy consuming units. Further, the first and the second charge controllers can be configured to route their respective excess amount of energy to the master charge controller and to receive their respective deficit amount of energy from the master charge controller. In some examples, the master charge controller can be configured for controlling energy distribution based on the amounts of excess energy and/or deficit energy at either or both of the first and the second charge controllers.

In some examples, the one or more first and second consuming units can include one or more of respective storage batteries, appliances, and inverters. In some examples, the first and second PV sub-systems can include their respective first and second bi-directional meters for routing the energy exchange with the master charge controller. In some examples, the solar-electrical energy distribution system can further comprise a master bi-directional meter operatively coupled to the master charge controller and configured to route the energy exchange between the external grid and the master controller. In some examples, the solar-electrical energy distribution system can further include a master storage battery operatively coupled to the master charge controller and configured to store electrical energy.

According to a sixth aspect of the presently disclosed subject matter there is provided a method for solar-electrical energy distribution, said method comprising: providing the solar-electrical energy distribution system according to any example described herein with respect to the fifth aspect; receiving, by the first charge controller, the electrical energy produced by the first PV array; distributing, by the first charge controller, of the electrical energy produced by the first PV array to the one or more first energy consuming units based on the amount of energy produced by the first PV array and amount of energy required by the one or more first energy consuming units; routing, by the first charge controller, a corresponding energy excess to the master charge controller or reporting, by the first charge controller, a corresponding energy deficit to the master charge controller; receiving, by the second charge controller, the electrical energy produced by the second PV array; distributing, by the second charge controller, of the electrical energy produced by the second PV array to the one or more second energy consuming units based on the amount of energy produced by the second PV array and amount of energy required by the one or more second energy consuming units; routing, by the second charge controller, a corresponding energy excess to the master charge controller or reporting, by the second charge controller, a corresponding energy deficit to the master charge controller; receiving, by the master charge controller, respective energy excess and/or energy deficit requests from the first and second charge controllers; distributing electrical energy between the first and second charge controllers and an external grid based on the received respective energy excess and/or energy deficit requests.

According to a seventh aspect of the presently disclosed subject matter there is provided a kit comprising: at least one first PV roof module inter-connectable with at least one other like-module to form a roof of a building, said first PV roof module being configured for producing electrical energy from solar energy; a first charge controller configured for operatively coupling to the first PV roof module and controlling distribution of electrical energy produced by the first roof module to one or more first energy consuming units; at least one second PV roof module inter-connectable with at least one other like-module to form a roof of a building, said second PV roof module being configured for producing electrical energy from solar energy; a second charge controller configured for operatively coupling to the second PV roof module and controlling distribution of electrical energy produced by the second roof module to one or more second energy consuming units; and a master charge controller configured for operatively coupling to the first and second charge controllers to exchange electrical energy with each of the first and second charge controllers and to control energy distribution between the first and second charge controllers and an external grid. In some examples, at least one of the first and second roof modules is the roof module according to any example described herein with respect to the first aspect.

In some examples, the kit can further comprise at least one anchor module inter-connectable with at least one of the first and second PV roof modules and configured to introduce energy produced by the roof module into an interior of the corresponding building. The at least one anchor module can be the anchor module according to any example described herein with respect to the second aspect.

It is to be understood herein that the presently disclosed matter facilitates not only deployment of a PV network per building or per household, but also deployment of scalable PV based electrical networks which can efficiently handle entire neighborhoods. The modular approach is key for the deployment success as retrofit or addon solutions cannot support the economics of such cases as the modular case can be used for larger deployment areas (e.g., all roof areas are by design candidates for PV integration built-in).

The term structural frame can denote any structure which can support the module on top of a building, e.g., a frame comprising struts and studs, a structural member comprised of structural foam having stability qualities, or any equivalent thereof.

A more specific description is provided in the Detailed Description whilst the following are non-limiting examples of different embodiments of the presently disclosed subject matter.

In some embodiments, a roof module inter-connectable with at least one other like-modules to form a roof of a building, said roof module comprising a structural frame having a first couplable zone and a second couplable zone, said first couplable zone being readily couplable to a respective second couplable zone of a respective like-module; a Photo Voltaic (PV) layer connected to said structural frame at least partially between said couplable zones; a first connection element disposed at said first couplable zone and operatively connected to said PV layer; a second connection element disposed at said second couplable zone and operatively connected to said PV layer; said first connection element being operatively couplable with a respective second connection element of the respective like-module to facilitate an electrical connection between their respective PV layers.

In some embodiments, the roof module further comprises a functional layer associated with the roof including at least one of water insulation, thermal insulation, acoustic insulation, fire insulation, withstanding seismic lateral forces, drainage, and providing protection to an interior of the building from conditions including sunshine, rain, snow, sleet, hail, and/or winds.

In some embodiments, said roof module is inter-connectable with said respective like-module in a liquid sealable manner.

In some embodiments, the roof module comprises a front surface configured to face an exterior of the building, and opposite back surface configured to face an interior of the building, and a plurality of side surfaces extending between the front and back surfaces.

In some embodiments, a first side surface of the plurality of side surfaces at least partially includes said first couplable zone and a second side surface of the plurality of side surfaces at least partially includes said second couplable zone.

In some embodiments, the first side surface and second side surface face in directions opposite each other.

In some embodiments, the first side surface and second side surface face in directions transverse to each other.

In some embodiments, at least one of the first side surface and the second surface has a stepped profile when seen in a cross-section taken along a plane perpendicular to the respective side surface as well as to the first and/or second surface.

In some embodiments, the stepped profile is inter-lockable with a respective stepped profile of the respective like-module to provide said inter-connection between the two modules.

In some embodiments, at least one of the first side surface and the second surface has an inclined profile when seen in a cross-section taken along a plane perpendicular to the respective side surface as well as to the first and/or second surface.

In some embodiments, the inclined profile is inter-lockable with a respective inclined profile of the respective like-module to provide said inter-connection between the two modules.

In some embodiments, the roof module is inter-connectable to the respective like-module such that at least a portion of the front surface of the roof module overlaps at least a portion of a respective second surface of the respective like-module in a direction perpendicular to a direction of said inter-connection and/or at least a portion of a respective front surface of the respective like-module overlaps at least a portion of the back surface of the roof module in a direction perpendicular to a direction of said inter-connection.

In some embodiments, the front surface is configured to constitute a continuous roof surface with a respective front surface of the respective like-module when the modules are inter-connected to form the roof.

In some embodiments, at least one of the first and second connection elements is configured to facilitate establishment of a continuous and sealed plumbing line therethrough.

In some embodiments, the structural frame is at least partially hollow to allow said plumbing line to be routed therethrough.

In some embodiments, at least one of the first and second connection elements constitutes an electrical connector electrically coupled to the PV layer.

In some embodiments, the electrical connector is configured to electrically couple with a respective electrical connector of the respective like-module.

In some embodiments, a mechanical connection between the roof module and the respective like-module causes the electrical coupling between their respective electrical connectors.

In some embodiments, the back surface is free of electrical or plumbing connections with an interior of the building.

In some embodiments, the connection elements are concealed by the couplable zones when the roof module is inter-connected with the respective like-module.

In some embodiments, said second couplable zone is readily couplable to a respective first couplable zone of another respective like-module.

In some embodiments, said second connection element is operatively couplable with a respective first connection element of said other respective like-module to facilitate an electrical connection between their respective PV layers.

In some embodiments, the structural frame comprises a third couplable zone and a fourth couplable zone, said third couplable zone being readily couplable to a respective fourth couplable zone of one of said at least one like-module and said fourth couplable zone being readily couplable to a respective third couplable zone of one of said at least one like-module.

In some embodiments, the roof module further comprises a third connection element disposed at said third couplable zone and operatively connected to said PV layer, a fourth connection element disposed at said fourth couplable zone and operatively connected to said PV layer, said third connection element being operatively couplable with a respective fourth connection element of one of said at least one like-module to facilitate an electrical connection between their respective PV layers and said fourth connection element being operatively couplable with a respective third connection element of one of said at least one like-module to facilitate an electrical connection between their respective PV layers.

In some embodiments, at least one of the third couplable zone and fourth couplable zone is disposed laterally with respect to at least one of the first and second couplable zones.

In some embodiments, an anchor module inter-connectable with at least one roof module to introduce energy produced by the roof module into an interior of the building is provided, said anchor module comprising an anchor structural frame having a first anchor couplable zone readily couplable with at least one of said first and second couplable zones of said roof module; and a first anchor connection element disposed at the first anchor couplable zone and operatively couplable with a respective connection element of said roof module.

In some embodiments, the anchor module is inter-connectable with said roof module in a liquid sealable manner.

In some embodiments, the first anchor couplable zone has a stepped profile inter-lockable with a respective stepped profile of said roof module.

In some embodiments, the first anchor couplable zone has an inclined profile inter-lockable with a respective inclined profile of said roof module.

In some embodiments, the anchor module is inter-connectable to the roof module such that at least a portion of the front surface of the roof module overlaps at least a portion of the anchor module in a direction perpendicular to a direction of said inter-connection or at least a portion of the anchor module overlaps at least a portion of the back surface of the roof module in a direction perpendicular to a direction of said inter-connection.

In some embodiments, the first anchor connection element is configured to facilitate establishment of a continuous and sealed plumbing line therethrough.

In some embodiments, the anchor module is at least partially hollow to allow said plumbing line to be routed therethrough.

In some embodiments, the first anchor connection element constitutes an electrical connector.

In some embodiments, the electrical connector is configured to electrically couple with a respective electrical connector of the roof module.

In some embodiments, a mechanical connection between the anchor module and the roof module causes the electrical coupling between their respective electrical connectors.

In some embodiments, the anchor module is configured to establish electrical and/or plumbing connections with the interior of the building.

In some embodiments, the first anchor couplable zone is readily couplable with any of said first and second couplable zones of said roof module.

In some embodiments, the anchor structural frame further comprises a second anchor couplable zone readily couplable with a respective couplable zone of another one of the at least one roof module.

In some embodiments, the anchor module further comprises a second anchor connection element disposed at the second anchor couplable zone and operatively couplable with a respective connection element of said other one of the at least one roof module.

In some embodiments, the anchor module further comprises a PV layer electrically couplable with the first anchor connection element.

In some embodiments, a kit is provided, the kit comprising at least one roof module; and at least one anchor module.

In some embodiments, the kit further comprising at least two anchor modules.

In some embodiments, the kit further comprises at least two roof modules; at least two charge controllers each configured to be operatively coupled to a respective one of the at least two roof modules and configured to control energy production and distribution by the respective roof module; and at least one master charge controller configured to be operatively coupled to each one of the charge controllers and to control exchange of electrical energy between the charge controllers and an external grid.

In some embodiments, a modular roof of a building is provided, said roof comprising: a plurality of roof modules, a first roof module and a second roof module of the plurality of roof modules being inter-connected to each other via their respective couplable zones, wherein the first couplable zone of the first roof module is coupled to the second couplable zone of the second roof module, and the first connection element of the first roof module is operatively coupled with the second connection element of the second roof module having established an electrical connection between the respective PV layers of the two modules therethrough.

In some embodiments, the modular roof further comprises at least one anchor module inter-connected with at least one of the first and second roof modules, wherein the first anchor couplable zone of the anchor module is coupled with a respective couplable zone of said at least one of the first and second roof modules, and the first anchor connection element of the anchor module is operatively coupled with a respective connection element of said least one of the first and second roof modules having established an electrical connection between the anchor module and said at least one of the first and second roof modules.

In some embodiments, the anchor module is operatively coupled with an interior of the building to facilitate electrical and/or plumbing connection therewith.

In some embodiments, the modular roof further comprises at least one non-PV roof module comprising couplable zones corresponding to those of the plurality of roof modules, and being free of a PV layer, said at least one non-PV roof module being inter-connected to at least one of the plurality of roof modules.

In some embodiments, a solar-electrical energy distribution system is provided comprising a first Photo Voltaic (PV) sub-system comprising a first PV array configured for producing electrical energy from solar energy; one or more first energy consuming units configured to consume electrical energy; and a first charge controller configured for controlling energy distribution to the one or more first energy consuming units; a second Photo Voltaic (PV) sub-system comprising a second PV array configured for producing electrical energy from solar energy; one or more second energy consuming units configured to consume electrical energy; and a second charge controller configured for controlling energy distribution to the one or more second energy consuming units; and a master charge controller operatively coupled to the first and second charge controllers, said master charge controller being configured to exchange electrical energy with each of the first and second charge controllers and to control energy distribution between the first and second charge controllers and an external grid.

In some embodiments, the first charge controller is configured for controlling energy distribution based on an amount of energy produced by the first PV array and amount of energy required by the one or more first energy consuming units, and the second charge controller is configured for controlling energy distribution based on an amount of energy produced by the second PV array and amount of energy required by the one or more second energy consuming units.

In some embodiments, the first and the second charge controllers are configured to route their respective excess amount of energy to the master charge controller and to receive their respective deficit amount of energy from the master charge controller.

In some embodiments, the master charge controller is configured for controlling energy distribution based on the amounts of excess energy and/or deficit energy at either or both of the first and the second charge controllers.

In some embodiments, the one or more first and second consuming units include one or more of respective storage batteries, appliances, and inverters.

In some embodiments, the first and second PV sub-systems include their respective first and second bi-directional meters for routing the energy exchange with the master charge controller.

In some embodiments, the solar-electrical energy distribution system further comprises a master bi-directional meter operatively coupled to the master charge controller and configured to route the energy exchange between the external grid and the master controller.

In some embodiments, the solar-electrical energy distribution system further comprises a master storage battery operatively coupled to the master charge controller and configured to store electrical energy.

In some embodiments, a method for solar-electrical energy distribution is provided, said method comprising: providing the solar-electrical energy distribution system; receiving, by the first charge controller, the electrical energy produced by the first PV array; distributing, by the first charge controller, of the electrical energy produced by the first PV array to the one or more first energy consuming units based on the amount of energy produced by the first PV array and amount of energy required by the one or more first energy consuming units; routing, by the first charge controller, a corresponding energy excess to the master charge controller or reporting, by the first charge controller, a corresponding energy deficit to the master charge controller; receiving, by the second charge controller, the electrical energy produced by the second PV array; distributing, by the second charge controller, of the electrical energy produced by the second PV array to the one or more second energy consuming units based on the amount of energy produced by the second PV array and amount of energy required by the one or more second energy consuming units; routing, by the second charge controller, a corresponding energy excess to the master charge controller or reporting, by the second charge controller, a corresponding energy deficit to the master charge controller; receiving, by the master charge controller, respective energy excess and/or energy deficit requests from the first and second charge controllers; and distributing electrical energy between the first and second charge controllers and an external grid based on the received respective energy excess and/or energy deficit requests.

In some embodiments, a kit is provided, the kit comprising at least one first PV roof module inter-connectable with at least one other like-module to form a roof of a building, said first PV roof module being configured for producing electrical energy from solar energy; a first charge controller configured for operatively coupling to the first PV roof module and controlling distribution of electrical energy produced by the first roof module to one or more first energy consuming units; at least one second PV roof module inter-connectable with at least one other like-module to form a roof of a building, said second PV roof module being configured for producing electrical energy from solar energy; a second charge controller configured for operatively coupling to the second PV roof module and controlling distribution of electrical energy produced by the second roof module to one or more second energy consuming units; and a master charge controller configured for operatively coupling to the first and second charge controllers to exchange electrical energy with each of the first and second charge controllers and to control energy distribution between the first and second charge controllers and an external grid.

In some embodiments, at least one of the first and second roof modules is the roof module.

In some embodiments, the kit further comprises at least one anchor module inter-connectable with at least one of the first and second PV roof modules and configured to introduce energy produced by the roof module into an interior of the corresponding building. In some embodiments, the at least one anchor module is the anchor module.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A illustrates a top perspective view of a roof module according to an example of the presently disclosed subject matter showing only its structural frame;

FIG. 1B illustrates the roof module of FIG. 1A with a sheathing layer;

FIG. 1C illustrates the roof module of FIG. 1A with an insulation layer;

FIG. 1D illustrates the roof module of FIG. 1A with a Photo Voltaic (PV) layer;

FIG. 1E illustrates the roof module of FIG. 1D with a glass frame;

FIG. 2A illustrates a bottom perspective view of a roof module according to another example of the presently disclosed subject matter showing its connection points;

FIG. 2B illustrates a top perspective view of a roof module according to yet another example of the presently disclosed subject matter showing its connection points;

FIG. 3A illustrates a top perspective view of a modular roof according to an example of the presently disclosed subject matter;

FIG. 3B illustrates a side view of the modular roof of FIG. 3A;

FIG. 3C illustrates sectional views of the modular roof of FIG. 3A showing inter-connections of its roof modules according to an example of the presently disclosed subject matter;

FIG. 3D illustrates sectional views of the modular roof of FIG. 3A showing inter-connections of its roof modules according to another example of the presently disclosed subject matter;

FIG. 3E illustrates a side view of a modular roof according to another example of the presently disclosed subject matter;

FIG. 3F illustrates a side view of a modular roof according to yet another example of the presently disclosed subject matter;

FIGS. 4A-4C illustrate various configurations of energy production and control by the roof system according to various examples of the presently disclosed subject matter;

FIGS. 5A-5C illustrate various configurations of energy production and distribution by the roof system according to various examples of the presently disclosed subject matter; and

FIG. 6 illustrates a solar-electrical energy distribution system according to an example of the presently disclosed subject matter.

### DETAILED DESCRIPTION

The following detailed description sets forth general and specific details about features of the molds according to various aspects and examples of the presently disclosed subject matter.

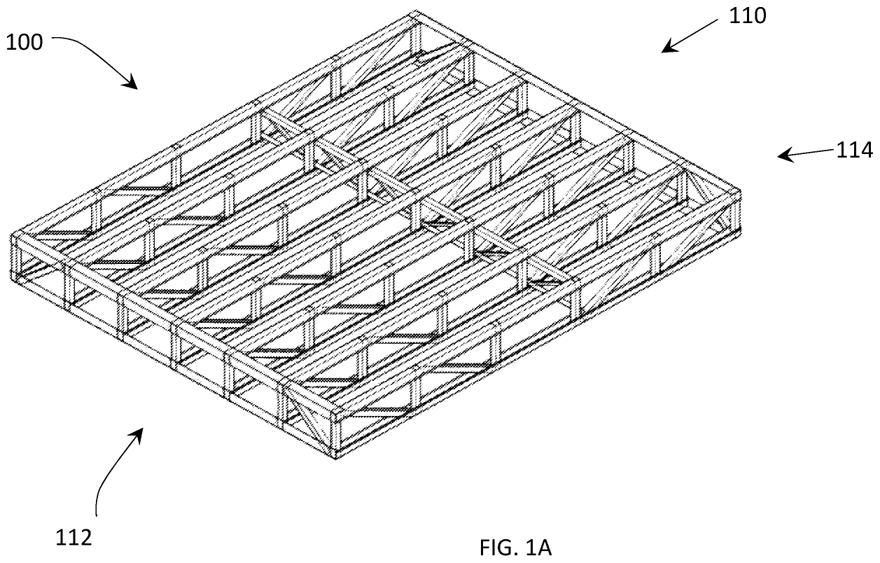

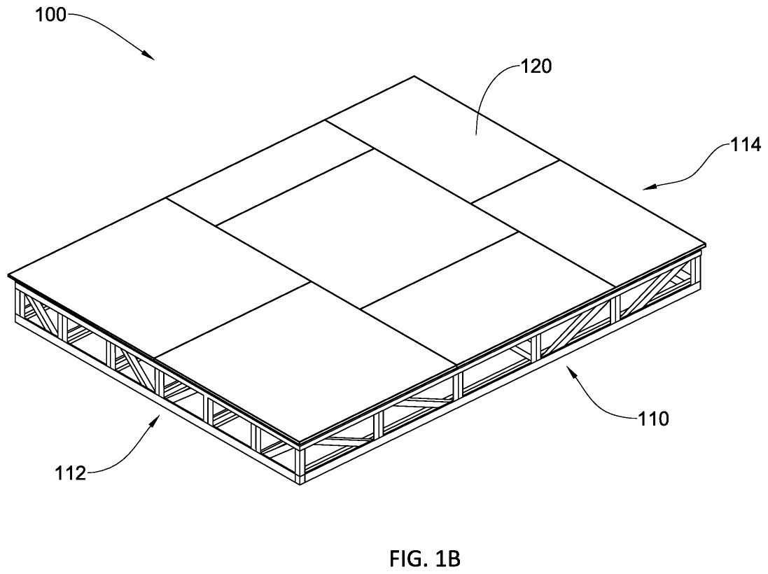

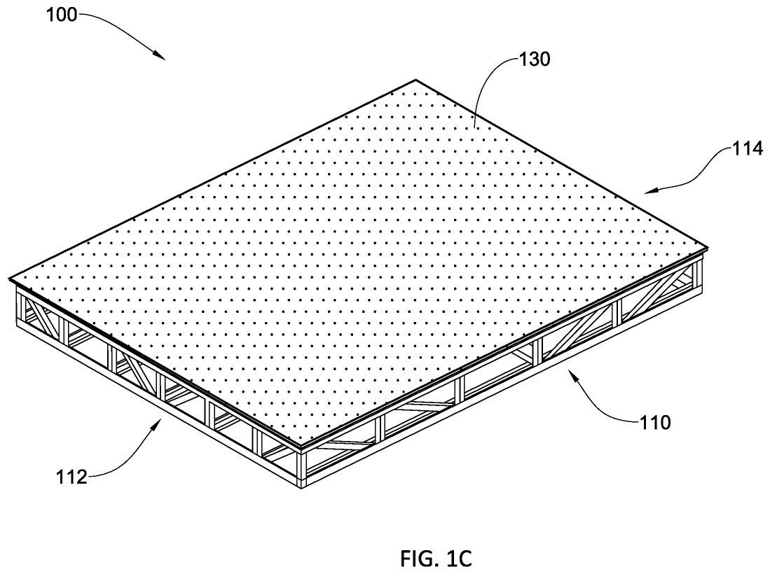

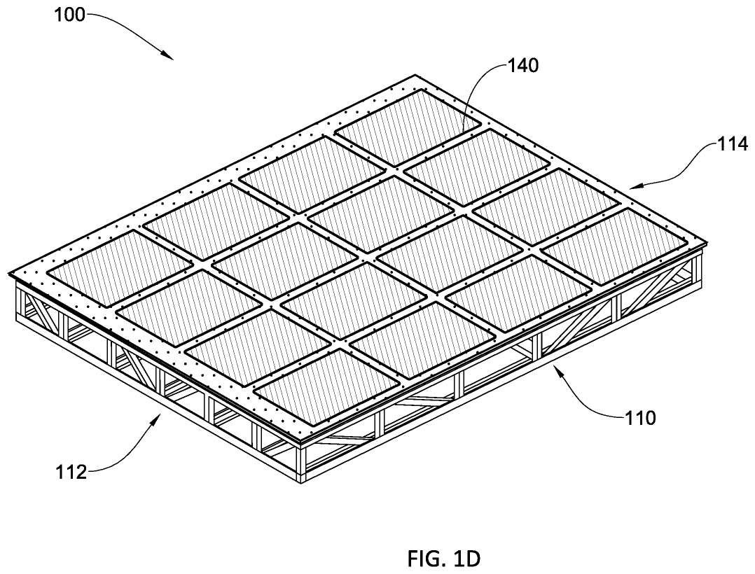

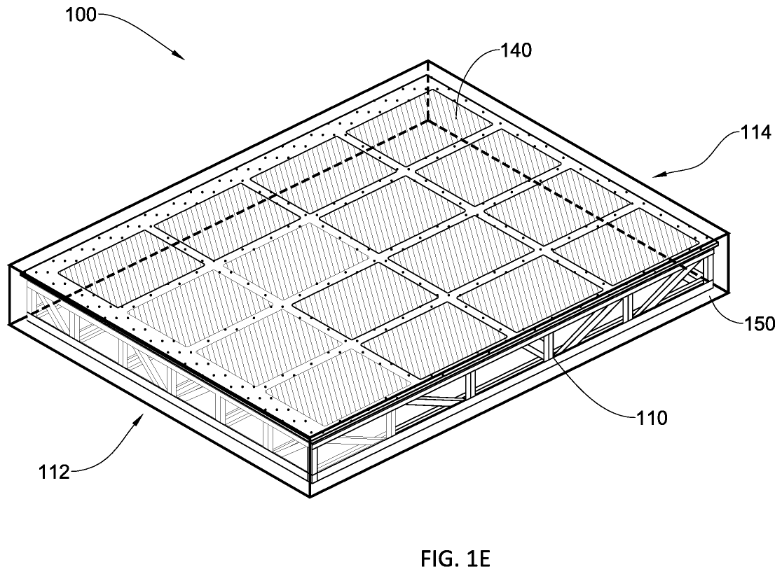

Reference is first made to FIGS. 1A-1E illustrating a schematic of a roof module 100 according to an example of the presently disclosed subject matter. The roof module 100 is prefabricated in a manufacturing unit in advance prior to reaching the construction site to be inter-connected with one or more like-modules to form a roof of a building on the construction site. The roof module 100 thus prefabricated can be assembled modularly with other like-modules to construct the roof on the site. The roof module 100 is prefabricated according to the design and dimension requirements on the construction site. A large roof area can be constructed from at least one roof module, however generally several modules are required as there is some physical limit, such as manufacturability, transport capabilities and specific onsite construction limitations to a single module size. The exact size, design, shape, and dimensions of a single roof module can also be affected by other structural restrictions which favor certain supporting regions than other regions hence determining the tiling direction and trajectory. In addition, it is noted that all roof modules may or may not be of the same size.

It is to be understood herein for the purposes of the present description (i.e., for all the examples of roof modules described herein) that the like-modules can be similar or identical to the roof module at least at the corresponding couplable zones for liquid sealed coupling with the roof modules. In some examples, one or more of the like-modules can be exactly identical to the roof module 100 (or other roof modules described herein) and include all the features thereof. In some examples, one or more of the like-modules may not be exactly identical, and only similar, to the roof module 100 (or other roof modules described herein) and may include only some of the features thereof. In some examples, one or more of the like-modules may include only the features of the roof module 100 (or other roof modules described herein) related to coupling or inter-connecting therewith in a liquid-sealed manner. In some examples, the like-module can be an anchor module configured for inter-connecting to the roof module in a manner similar to any other like-module and to establish a connection between the roof module and an interior of the building.

The roof thus formed is configured to perform all the functions, or at least one function, associated with roofs such as but not limited to water insulation, thermal insulation, acoustic insulation, fire insulation, withstanding seismic lateral forces, drainage, and providing protection to an interior of the building from conditions including sunshine, rain, snow, sleet, hail, and/or winds. The complete roof construct not only functions as a regular roof but can be connected to an energy control system (for example, via a plug-and-play connecting interface) for energy production, storage, control, and distribution purposes, as described later herein below.

The roof module 100 includes a structural frame 110, which has a first couplable zone 112 and a second couplable zone 114. The first and the second couplable zones 112 and 114 are readily (modularly) couplable to respective couplable zones of the one or more like-modules. For instance, the first couplable zone 112 is readily couplable to a respective second couplable zone of a like-module and the second couplable zone 114 is readily couplable to a respective first couplable zone of another like-module. The arrangement, configuration, material, strength, and dimensions including length, width, and height (thickness) of the structural frame 110 is determined according to the required layout and positioning of the roof module 100 depending on the circumstances (e.g., expected wind load, slope of the roof area, etc.).

According to an example illustrated in FIG. 1B, the roof module 100 includes a sheathing layer 120 disposed on the structural frame 110, for increasing the roof module's 100 ability to withstand seismic lateral forces.

According to another example illustrated in FIG. 1C, the roof module 100 includes an insulation material layer 130 for water insulation and/or thermal insulation and/or acoustic insulation and/or fire insulation. It is to be understood herein that all or some of the functionalities of the layers 120 and 130 can be implemented using several layers with each layer having its own function or can be combined into a single layer.

According to another example illustrated in FIG. 1D, the roof module 100 includes a photovoltaic (PV) layer 140 connected to the structural frame 110. It is to be understood herein that the PV layer 140 can be directly connected to the structural frame 110 or can be connected through an intermediate functional layer (such as one or more of layers 120 and 130). In some examples, the roof module may not include any functional layers. In some examples, the functionalities of one or more of the layers 120 and/or 130 can be implemented within the PV layer 140, for example by a substrate of the PV layer 140. In some examples, the PV layer 140 can include a single PV module which consists of a number of PV cells connected in series and in parallel for producing electrical energy by converting solar energy. In some examples, the PV layer may include a PV array which consists of a number of PV modules. The number of cells and modules which are part of the PV layer 140 depends on the roof module size. The exact structure, size, element choices etc., for the PV modules are determined during the design phase itself.

According to another example illustrated in FIG. 1E, the roof module 100 is encompassed into a glass prism 150. In the illustrated example, the glass structure 150 provides complete sealing of the whole roof module 100. In some examples, the upper most layer (PV layer 140) can provide similar encompassing abilities, whereas the PV cells (or modules) themselves can be constructed on a substrate providing such features. In some examples the glass structure can be provided only on the top layer, for example, on top of the PV layer. The glass prism 150 functions a safety structure for the roof module 100 from water, dust, snow, etc. Also, the glass structure 150 can be used for providing a pre-determined amount of tilt to the overall roof module 100 for draining purposes.

It is to be understood herein that although the roof module 100 has been illustrated as being rectangular prism (or cuboidal) shaped, in some examples, all or some of the roof modules can have a different base shape (e.g., triangular, trapezoid, etc.) for covering roof areas which are not perfectly shaped as rectangles. In such examples, the roof can be of different sizes and of different shapes. The PV cells and modules structure can be optimized accordingly for achieving maximum coverage and efficiency.

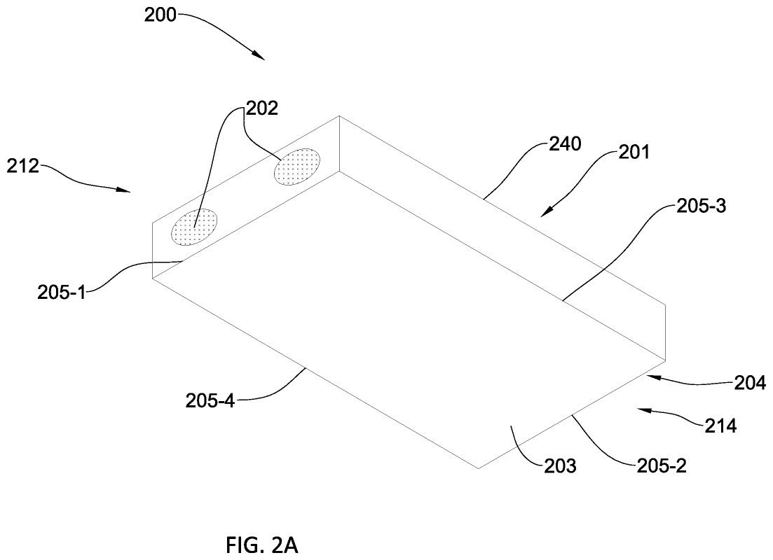

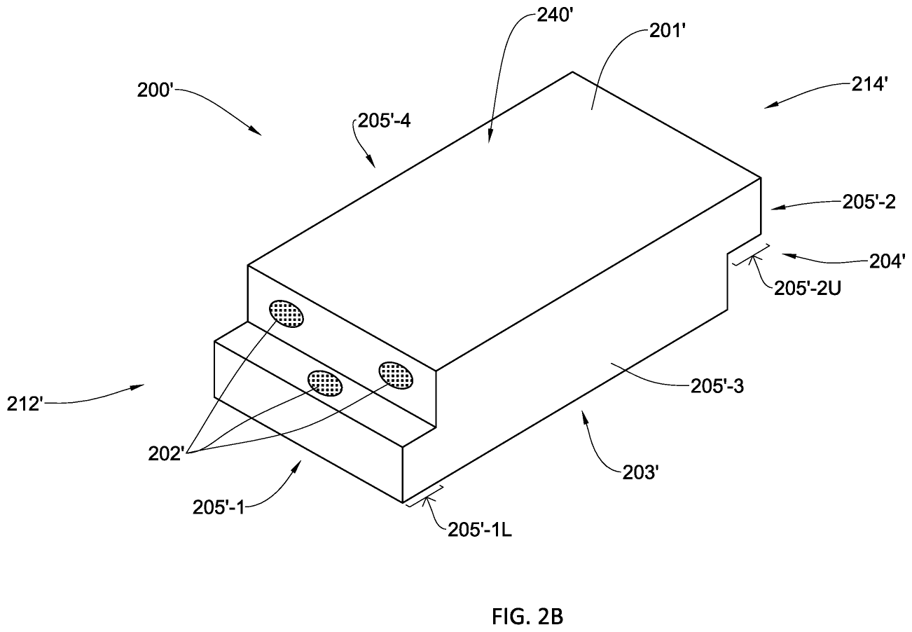

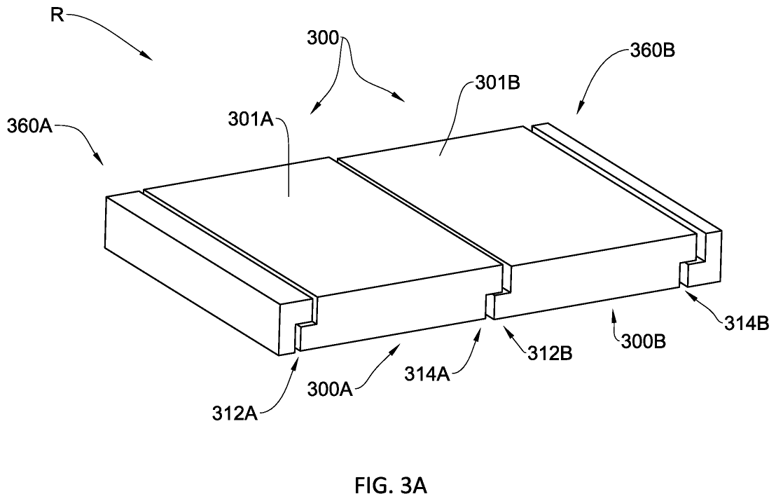

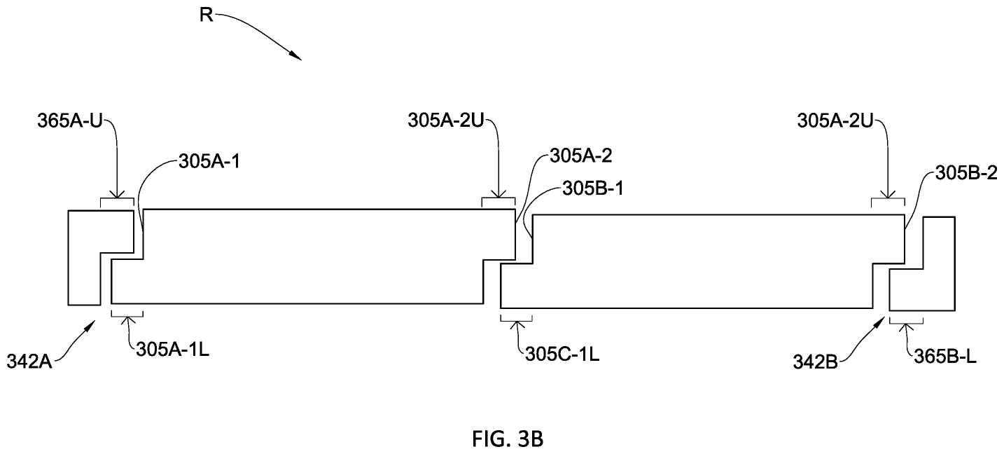

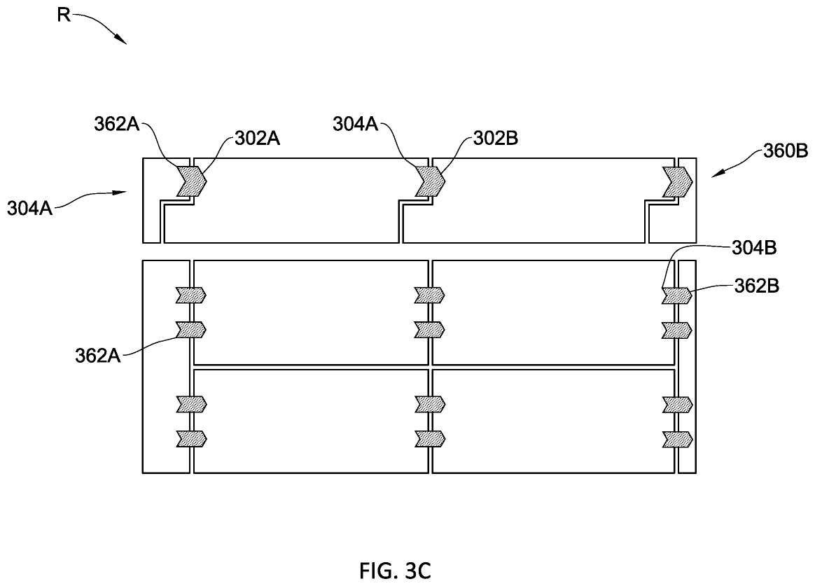

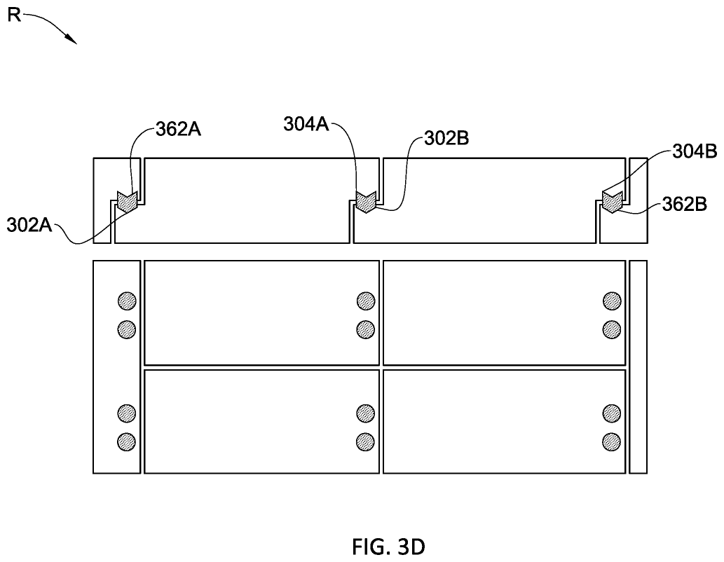

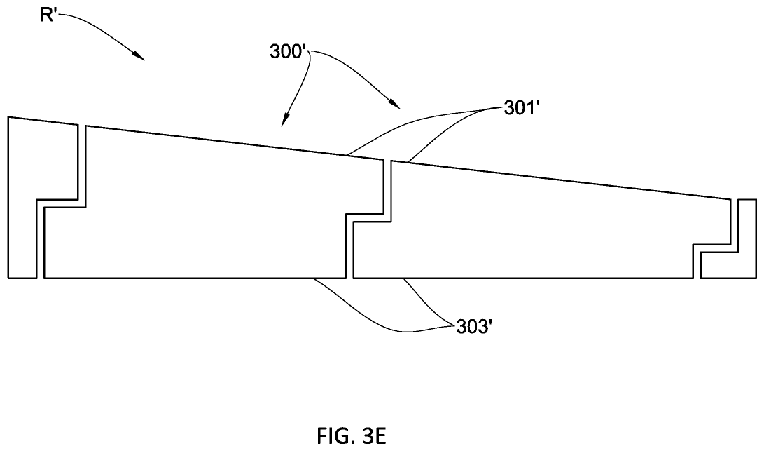

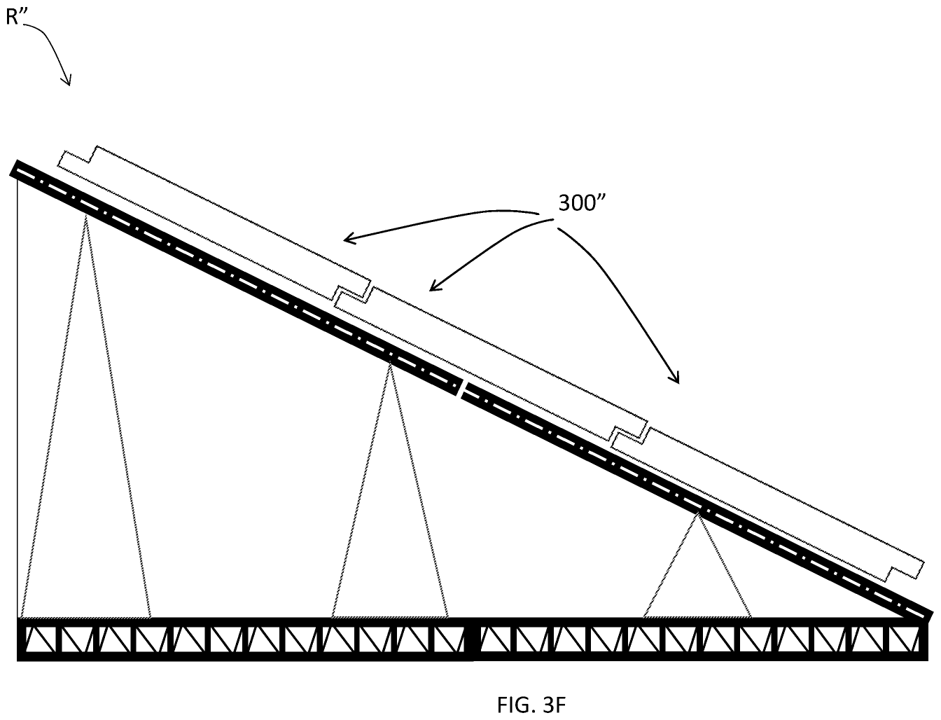

Although not illustrated, the PV layer 150 is electrically couplable with respective PV layers of the other like-modules. The electrical wiring setup of the PV layer 150 can be routed through the hollow structural frame to be electrically coupled to respective wiring setup of the PV layers of the other like-modules. The PV layers of various roof modules can be coupled to each other for energy distribution through respective connection elements provided at the roof modules as described in detail herein below with reference to FIGS. 2A, 2B, and 3A-3F.

Reference is now made to FIG. 2A illustrating a roof module 200 according to another example of the presently disclosed subject matter. The roof module 200 can be identical or similar to the roof module 100 described above according to various examples and may include some or all of the features thereof, and the description of such features of roof module 100 applies to those of the roof module 200 as well.

The roof module 200 includes a structural frame (not shown) having a first couplable zone 212 and a second couplable zone 214, each being configured for readily coupling to a respective couplable zone of a like-module. The roof module 200 further comprises a first connection element 202 disposed at the first couplable zone 212 and a second connection element 204 (not visible in FIG. 2A) disposed at the second couplable zone 214. Each of the first and second connection elements 202 and 204 are operatively connected to the PV layer 240 and are configured to operatively couple with respective connection elements of the like-modules. For instance, the first connection element 202 can operatively couple to a respective second connection element of a like-module, and the second connection element 204 can operatively couple to a respective first connection element of another like-module. The PV layers of the roof modules (i.e., the roof module and the like-modules to which the roof module 200 is to be connected to) can be electrically connected to each other via the respective connection elements.

In some examples, the connection elements 202 and 204 can be operatively coupled to the PV layer 240 by a hollow path established between the connection elements and the PV layer. In such examples, a wiring setup can be routed through the hollow path with an electrical connector disposed at or near the respective connection element for being connected to a corresponding electrical connector of the like-module during assembling of the roof by the roof modules. In some examples, the connection elements 202 and/or 204 can be implemented as electrical connectors electrically coupled to the PV layer 240.

The connection elements 202 and 204 are so disposed and configured as to establish the electrical connection between the PV layers of the two roof modules as and when the two roof modules are mechanically inter-connected to each other. For instance, the connection elements are configured to establish the electrical connection as and when the roof module 200 is modularly inter-connected with a like-module during assembly of the roof on the construction site.

The connection elements 202 and 204 can further facilitate MEP connections therethrough. For instance, the connection elements 202 and 204 can facilitate establishment of plumbing network lines routed through the hollow structural frames and the connection elements 202 and 204. When the roof modules are inter-connected to form the roof, the connection elements are concealed by the respective couplable zones. This provides protection to the connections from intentional/unintentional manual or natural accidents that may cause breakage in the connections.

The roof module 200 has a front surface 201 that faces an exterior of the building when the roof module is assembled to form the roof, a back surface 203 that faces an interior of the building when the roof module is assembled to form the roof, and the side surfaces 205-1, 205-2, 205-3, and 205-4 extending between the front surface 201 and the back surface 203. In some examples, the front surface 201 can be constituted by the PV layer. In some examples, the front surface can be constituted by a protective layer, for example a glass structure as described with reference to FIG. 1E.

The first side surface 205-1 constitutes the first couplable zone 212 and includes the first connection element 202, and the opposite side surface 205-2 constitutes the second couplable zone 214 and includes the second connection element 204. It is to be understood herein that in some examples, the second couplable zone and the second connection elements can be disposed at any of the other side surfaces 205-3 and 205-4, transverse to the side surfaces 205-1 and 205-2, as well. In some examples, all the four side surfaces can constitute respective couplable zone and can include respective connection elements. For instance, the structural frame can include a third couplable zone and a fourth couplable zone, whereas the third couplable zone can be readily couplable to a respective fourth couplable zone of a like-module and the fourth couplable zone can be readily couplable to a respective third couplable zone of another like-module. The third couplable zone can have a third connection element operatively connected to the PV layer, and the fourth couplable zone can have a fourth connection element operatively connected to said PV layer. The third connection element can be operatively couplable with a respective fourth connection element of a like-module to facilitate an electrical connection between their respective PV layers and the fourth connection element can be operatively couplable with a respective third connection element of another like-module to facilitate an electrical connection between their respective PV layers. It is to be understood herein that the four couplable zones can be disposed on any of the side surfaces, forming any combination of opposite or lateral positioning.

The front surface 201 of the roof module 200 and of each of the other like-modules is configured to constitute a continuous roof surface with the respective front surfaces of the like-modules when the roof is formed, as described in detail herein further below with respect to FIGS. 3A-3F. In some examples, the roof module 200 can be configured to facilitate establishment of MEP connections with the interior of the building, for example via the back surface 203. In some examples, the back 203 can be free of any MEP connections with the interior of the building, and such connections are provided through anchor modules, as described in detail herein further below with respect to FIGS. 3A-3F.

Although the roof module 200 has been shown to have a regular cuboidal shape, and the roof modules can be interconnected by simply placing the modules one adjacent to each other creating surface continuity, it is to be understood herein that different shapes/profiles for the roof modules can be used for various purposes.

For instance, in order to achieve a tighter and more effectively sealed connection between the roof modules, the side surfaces can be shaped and oriented in such a way so that when the roof module is inter-connected to the like-modules, at least a portion of the front surface of the roof module overlaps at least a portion of a respective second surface of the like-module in a direction perpendicular to a direction of the inter-connection and/or at least a portion of a respective front surface of the like-module overlaps at least a portion of the back surface of the roof module in a direction perpendicular to a direction of said inter-connection which allows one module weight to push and lean on the adjacent module hence better suited for water tight insulation or for locking certain connection arrangements between the modules. The overlap of the portions of the modules over portions of inter-connecting modules renders the front surfaces connected in a more efficient manner to constitute a continuous surface and provide a better liquid seal. Moreover, such connections better conceal the connection elements providing increased safety to the connections. Therefore, in some examples, to achieve such connections, the side surfaces can be shaped accordingly.

According to one such example illustrated in FIG. 2B, the side surfaces have a stepped profile when seen in a cross-section taken along a plane perpendicular to the respective side surface as well as to the first and/or second surface. FIG. 2B illustrates a roof module 200′ according to another example of the presently disclosed subject matter. The roof module 200′ can be identical or similar to the roof module 100 and/or the roof module 200′ described above according to various examples and may include some or all of the features thereof, and the description of such features of the roof modules 100 and/or 200 applies to those of the roof module 200′ as well.

The features of the roof module 200′ corresponding to those of the roof module 200 have been denoted by corresponding reference numerals. For instance, the roof module 200′ includes on its side surface 205′-1, a first couplable zone 212′ having a first connection element 202′ and on its side surface 205′-2 a second couplable zone 214′ having a second connection element 204′ (not visible in FIG. 2B). Each of the first and second connection elements 202′ and 204′ are operatively connected to the PV layer 240′ and are configured to operatively couple with respective connection elements of the like-modules. It is to be understood that the description of the side surface 205-1, first couplable zone 212, first connection element 202, side surface 205-2, second couplable zone 214, and second connection element 204 of the roof module 200 provided above applies to the side surface 205′-1, first couplable zone 212′, first connection element 202′, side surface 205′-2, second couplable zone 214′, and second connection element 204′ of the roof module 200′. The roof module 200′ is identical to the roof module 200 with the only difference being in the shape of the side surfaces 205′-1 and 205′-2.

As shown in FIG. 2B, the side surfaces 205′-1 and 205′-2 have a stepped profile when seen in a cross-section taken along a plane CP′ perpendicular to the respective side surfaces 205′-1 and 205′-2 as well as to the first and second surfaces 201′ and 203′, thereby forming an upper stepped portion 205′-2U at the side surface 205′-2 and a lower stepped portion 205′-1L at the side surface 205′-1. When the roof module 200′ is connected to the like-modules having corresponding stepped profile, the respective upper stepped portion of the like-module overlaps the lower stepped portion 205′-1L, and the upper stepped portion 205′-2U overlaps the respective upper stepped portion of another like-module thereby inter-locking the respective stepped profiles, as can be best seen in FIGS. 3A-3F.

According to another such example (not illustrated), the side surfaces have an inclined profile when seen in a cross-section taken along a plane perpendicular to the respective side surface as well as to the first and/or second surface (similar to the plane CP′ in FIG. 2B). The inclined profile can inter-lock with the corresponding inclined profile of the like-modules in a manner similar to the one explained above for the stepped profile, with the only difference being the inclined side surface instead of a stepped surface.

It is to be understood herein that although the roof modules as described above according to various examples are sufficient to form the roof, yet in some examples, the first and the last modules of the roof (i.e., on each edge of the roof) can be terminated by an anchor module. In some examples, an anchor module can be required for filling a gap between two roof modules depending on overall size and dimensions of the roof and size/dimensions of each roof module. The anchor module can be a smaller designed module with the purpose of filling a gap between the roof modules for complete roof coverage and/or locking down the roof modules assembly from end to end. The anchor modules may or may not include PV cells, and can facilitate MEP connection of the roof modules with the interior of the building. The anchor modules can facilitate routing of energy, control signals, plumbing connections, etc. between the roof and the interior of the building, as described in detail herein below with reference to FIGS. 3A-3F.

Reference is now made to FIGS. 3A-3F illustrating various views of modular roofs according to various examples of the presently disclosed subject matter. FIGS. 3A-3D illustrate a schematic of a small portion of a modular roof R formed by the roof modules 300 and anchor modules 360. It is to be understood herein that although the roof modules 300 have been illustrated as being identical to the roof module 200′ described above, the roof modules according to any other examples described herein can also be used to construct a similar roof. The roof modules 300 include 300A and 300B inter-connected to each other. According to the illustrated example, each of the roof modules 300A and 300B are identical to the roof module 200′ and the features corresponding to those of the roof module 200′ have been denoted by corresponding reference numerals.

As shown in FIGS. 3A-3D, the second couplable zone 314A of the roof module 300A is coupled to the first couplable zone 312B of the roof module 300B with their respective front surfaces 301A and 301B constituting a continuous surface of the roof R. The side surfaces 305A-1 and 305A-2 of the roof module 300A have a stepped profile, thereby forming an upper stepped portion 305A-2U at the side surface 305A-2 and a lower stepped portion 305A-1L at the side surface 305A-1. The side surfaces 305B-1 and 305B-2 of the roof module 300B have a stepped profile, thereby forming an upper stepped portion 305B-2U at the side surface 305B-2 and a lower stepped portion 305B-1L at the side surface 305B-1. The upper stepped portion 305A-2U of the roof module 300A overlaps the lower stepped portion 305B-1L, thereby inter-locking the respective stepped profiles of the roof modules 300A and 300B.

The anchor modules 360, in the examples illustrated in FIGS. 3A-3F, have been shown to have stepped profile, however, it is to be understood herein that the anchor modules can have any shape/profile of their respective couplable zones corresponding to the shape/profile of couplable zones of the roof modules. In the illustrated examples, the anchor modules 360 include two anchor modules 360A and 360B, each having a respective structural frame (not shown) comprising a first anchor couplable zone 372A and 372B, each being configured for readily coupling to a respective couplable zone of a roof module. Each of the anchor modules 360A and 360B have respective first anchor connection elements 362A and 362B disposed at their respective first couplable zones 372A and 372B, each of the anchor connection elements 362A and 362B being operatively couplable to the corresponding connection elements of the roof modules.

Although the anchor modules have been shown to be loosely connected to the roof modules, for better illustration purposes, it is to be understood that the anchor modules are connected to the roof modules in a liquid sealed manner while their respective front surfaces constitute a continuous roof surface. For instance, the anchor modules 360A and 360B have a stepped profile at their respective anchor couplable zones 372A and 372B corresponding to the stepped profiles of the roof modules and inter-lockable therewith, as shown. In some examples, especially when the roof modules have inclined profiles, the anchor modules can be formed with corresponding inclined profiles inter-connectable therewith. Preferably, irrespective of the profile of the couplable zones, the anchor modules and the roof modules are inter-connectable such that at least a portion of the front surface of the roof module overlaps at least a portion of the anchor module in a direction perpendicular to a direction of said inter-connection and/or at least a portion of the anchor module overlaps at least a portion of the back surface of the roof module in a direction perpendicular to a direction of said inter-connection. For example, the anchor module 360A has an upper stepped portion 365A-U that overlaps a corresponding a lower stepped portion 305A-1L of the roof module 300A, and the upper stepped portion 305B-2U of the roof module 300B overlaps a lower stepped portion 365B-L of the anchor module 360B.

As can be best seen in FIGS. 3C and 3D, the first anchor connection elements 362A of the anchor module are operatively connected to the first connection elements 302A of the roof module 300A, and the first connection elements 362B of the anchor module 360B are operatively connected to the second connection elements 304B of the roof module 300B. The connection elements of the anchor modules as well as the roof modules can facilitate establishment of MEP connections between the modules therethrough, thereby connecting the modules of the whole roof together, and with an interior of the building. For instance, the connection elements can facilitate establishment of plumbing network lines routed through the hollow structural frames of the roof modules and the anchor modules.

In some examples, the connection elements 362A and 362B can be implemented as electrical connectors electrically couplable to the corresponding electrical connectors of the roof modules. The connection elements 302A, 302B, 304A, 304B, 362A, and 362B are so disposed and configured as to establish the electrical connections therebetween as and when the anchor modules and roof modules are mechanically inter-connected to each other to form the roof. For instance, the connection elements are configured to establish the electrical connection as and when the modules are modularly inter-connected during assembly of the roof on the construction site. When the roof modules are inter-connected to form the roof, the connection elements are concealed by the respective couplable zones. This provides protection to the connections from intentional/unintentional manual or natural accidents that may cause breakage in the connections. For the purposes of this protection, the connection elements can be oriented in various directions. For example, as shown in FIG. 3C, the connection elements are oriented to be connected in the direction of connections of the modules, i.e., in a direction parallel to the roof. However, in FIG. 3D, the connection elements are oriented to be connected in a direction transverse to the roof, thereby providing more efficient concealment from external evenets.

Although the anchor modules 360 have been described as constituting the termination modules for the roof, it is to be understood herein that the anchor modules can also be configured (shaped, sized, designed, etc.) to serve the purpose of filling the gaps between two roof modules. For instance, the anchor modules can be constructed to include second anchor couplable zones opposite, or laterally disposed to the first anchor couplable zones, readily couplable with a respective couplable zone of another roof module. Such an anchor module can further include a second anchor connection element disposed at the second anchor couplable zone and operatively couplable with a respective connection element of that other roof module. One such example of the anchor module can be a T-shaped module.

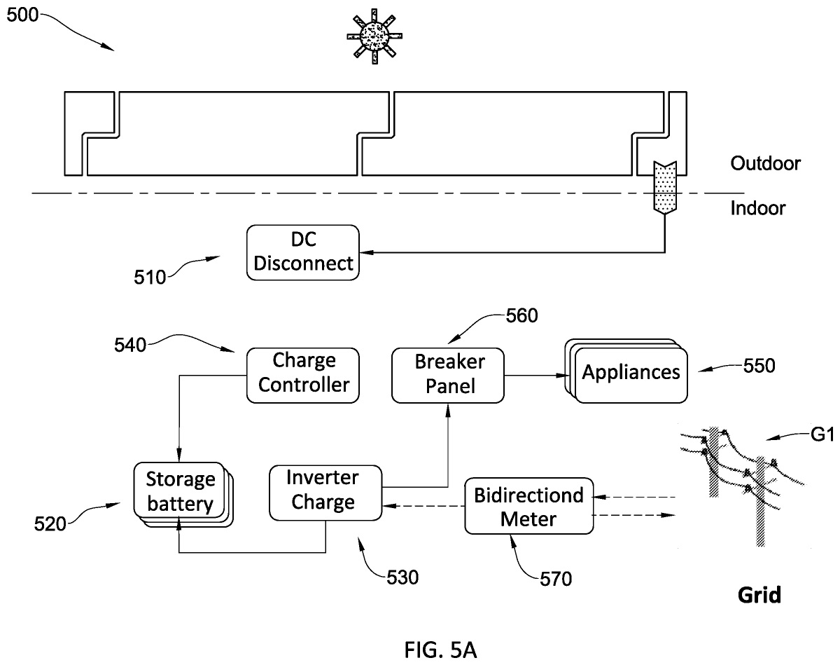

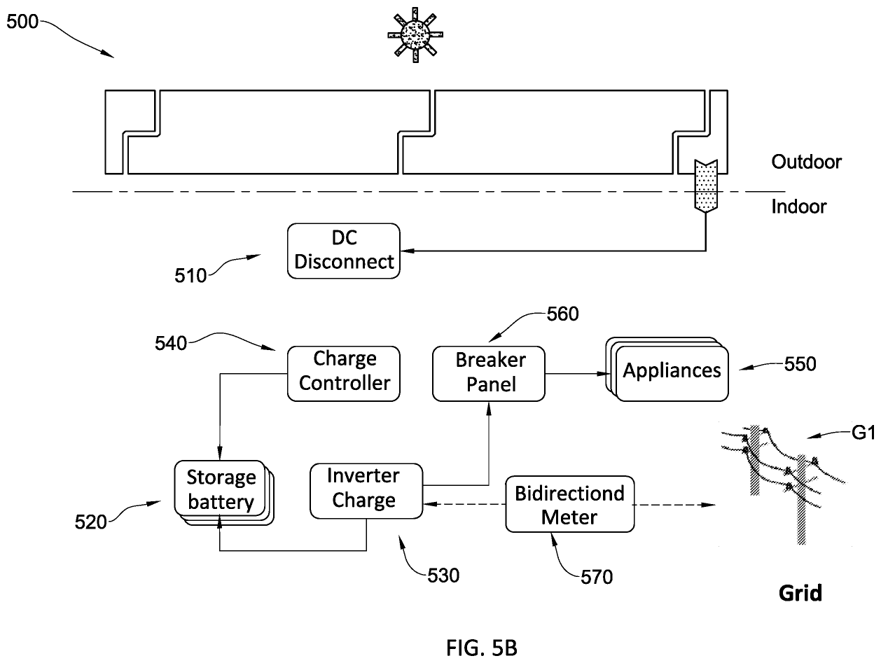

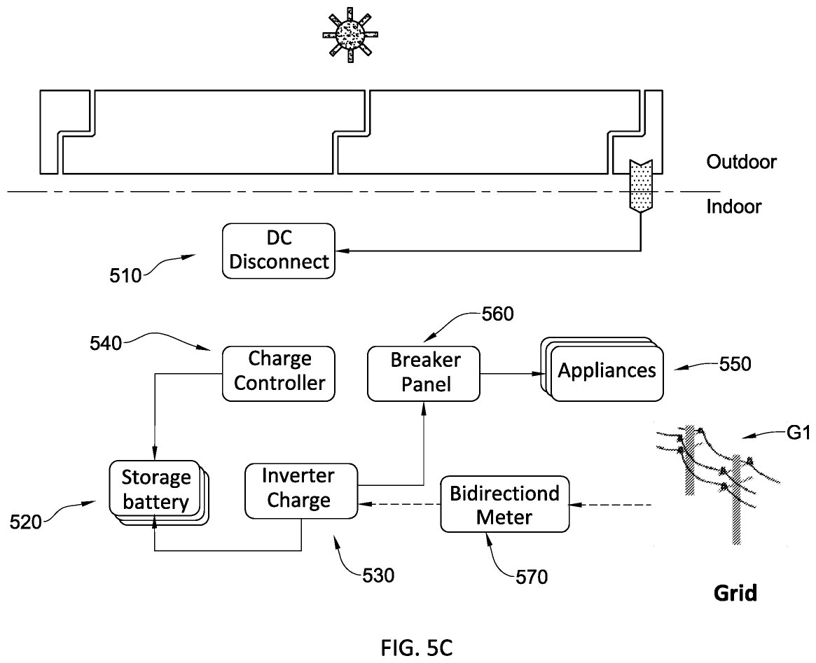

Although generally, the anchor modules are small in size and are free of PV layers, in some examples, the anchor modules can as well include the PV cells or layers. In any case, the anchor modules are configured to facilitate connections (electrical mechanical, plumbing) between the roof and the interior of the building. For instance, as can be best see in FIGS. 5A-5C, the anchor modules have building couplable zones and corresponding building connection elements configured to facilitate connections between the roof and the interior of the building. The energy produced by the roof modules, the drainage arrangement, plumbing arrangements, control signals, etc. can be routed through the anchor modules to and from the interior of the building. The roof modules and/or anchor modules can include one or more sensors configured to determine spatial related parameters with respect to the PV layers and the energy produced, such as but not limited to whether the PV cells are dirty or not, changing from DC to AC, receiving signals from the different modules, and enable turning on or off each module, which can be communicated with the interior of the building through the anchor modules. A system of the kind described above can include one anchor which has purely structural function, i.e., which does not include connection elements for electricity communication, and one which include those connection elements and which is configured to function as described.

FIG. 3E illustrates a modular roof R′ according to another example of the presently disclosed subject matter. According to the example illustrated in FIG. 3E, the roof modules 300′ have their respective front surfaces 301′ inclined with respect to the back surface 303′ for the drainage purposes. In cases where a small drainage angle is sufficient for proper drainage, or for avoiding dust accumulation on PV cells, this inclination can be achieved by designing the roof modules to maintain such a tilt by design and achieve a continuous tilt overall. As each roof module is manufactured according to a detailed design, the required tilt is considered and dictated at the prefabrication stage itself. This principle can be further advanced to include several slopes and inclinations following different draining trajectories as needed and required by the roof design.

However, in cases where a large drainage angle is required, a roof R″ can be constructed as shown in FIG. 3F. As shown in FIG. 3F, the last floor of the building is met with a flat ceiling with its own structural ceiling layer. Structural rafters are designed to maintain a required angle and the roof modules 300″ are tiled on top of the rafters in a similar manner as with a flat roof (for example, as shown in FIGS. 3A-3D). It is to be understood herein that such an arrangement provides different design considerations both from a structural perspective and insulation layering, the end results with respect to functionalities and strength are still maintained.

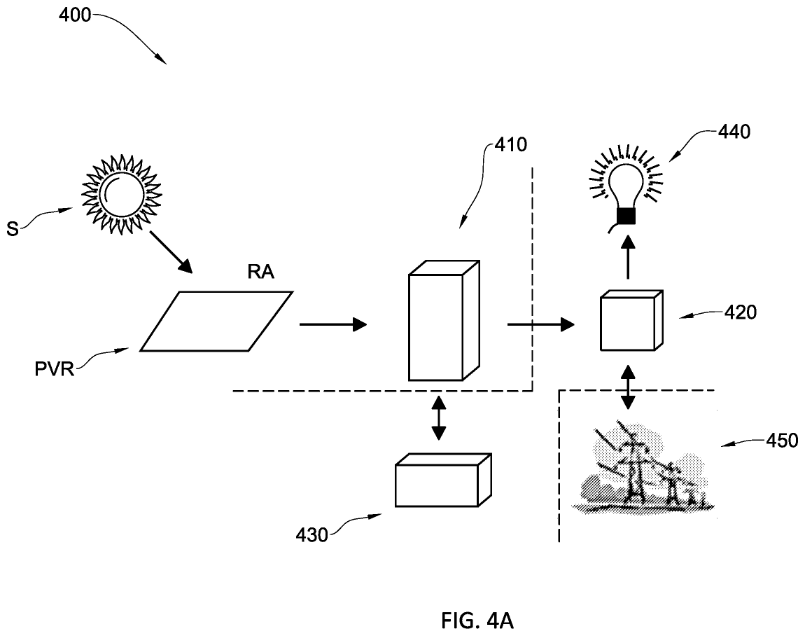

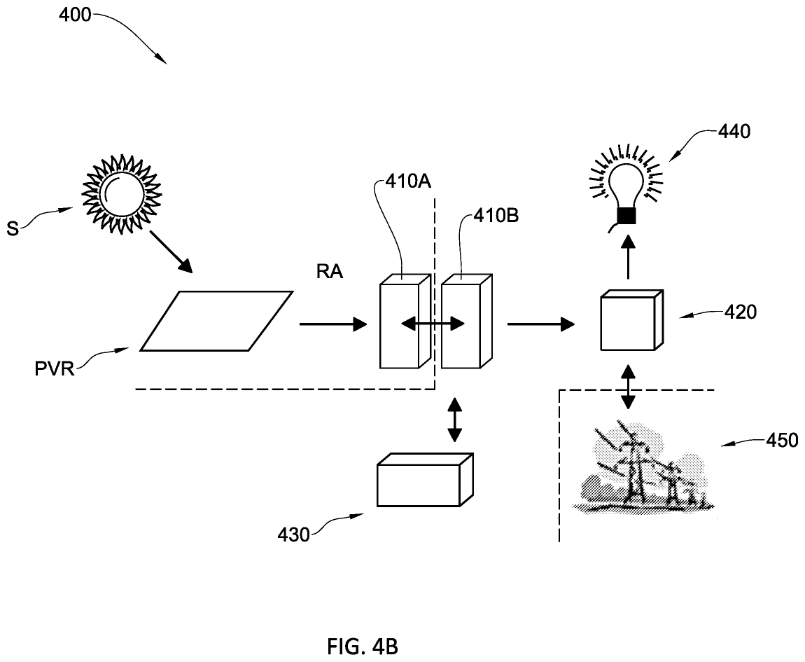

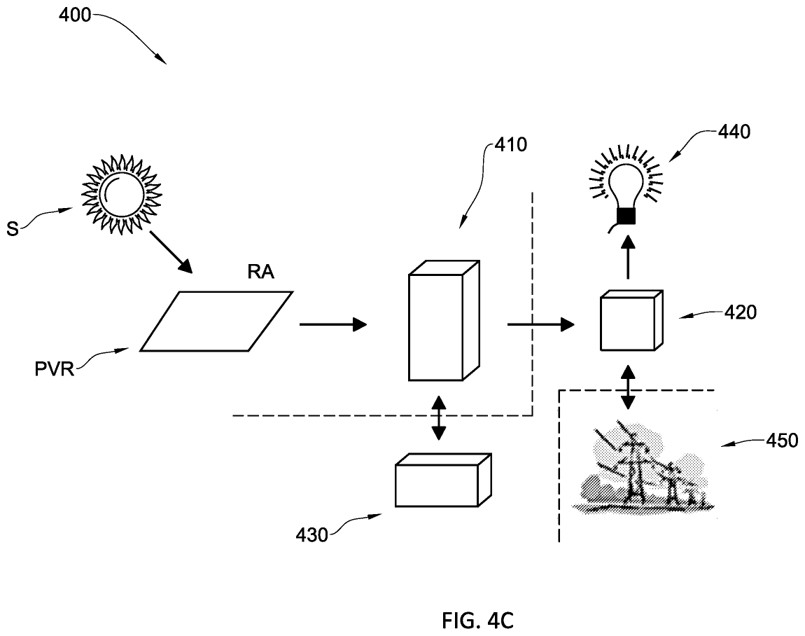

The presently disclosed subject matter further relates to control and distribution of the electrical energy. In some examples, the energy produced by the roof modules and/or roofs as described herein above can be controlled and distributed by the energy distribution systems disclosed herein, various architectures and implementations of which are described below with reference to FIGS. 4A-4C, FIGS. 5A-5C, and FIG. 6.

FIGS. 4A-4C illustrates a basic energy distribution system 400 considering the location of certain system components. While it is apparent that the PV modules and arrays are deployed outdoors and most of the appliances (electrical energy consumers) are located within the building, the energy control and conversion units can be positioned either indoors or outdoors. In some cases, it can be advantageous to perform necessary electrical conversions (DC to AC) on the roof and simplifying the deployment within the building. In some cases, it can be advantageous to perform necessary electrical conversions (DC to AC) on the roof and simplifying the deployment within the building.

The energy distribution system 400 includes a roof area RA having a PV roof PVR capable of producing electrical energy from the solar energy of the sun S. The produced energy is routed to energy inversion and conditioning unit 410 where the electrical conversions take place. The inverted energy is then forwarded to energy distribution unit 420 and/or to an energy storage unit (batteries) 430. The energy distribution unit 420 includes controllers to control the energy distribution between energy consumers 440 and/or an external grid utility 450.

According to the example illustrated in FIG. 4A, the energy inversion and conditioning unit 410 is located indoor and such processing is performed in the interior of the building. According to the example illustrated in FIG. 4B, the energy inversion and conditioning unit 410 is implemented with a hybrid approach whereas the energy inversion and conditioning unit 410 is divided into two units, outdoor unit 410A and indoor unit 410B. The part of the processing performed by the outdoor unit 410A is performed on the roof and the part of the processing performed by the indoor unit 410B is performed in the interior of the building. According to the example illustrated in FIG. 4C, the energy inversion and conditioning unit 410 is located outdoor and such processing is performed on the roof of the building.

FIGS. 5A-5C illustrate an energy distribution system 500 according to various examples of the presently disclosed subject matter with emphasis on the transition from the outdoor roof part to the indoor parts and interfacing with national or local electrical grid. In general, the electrical energy derived (DC Voltage) from the PV modules is driven indoors and connected to the main system by a DC connect (relay) system 510. Some of the DC power is used for charging batteries 520, i.e., storage, for regulating power use over time and for back up. Some of the DC power is converted through an inverter/converter charger 530 for proper appliance application (e.g., AC voltages for AC appliances, DC voltage for DC appliances). A charge controller 540 decides what portion of the PV derived energy to be used for storage or use. The appliances 550 are fed through a breaker panel 560. A national (or local) electric grid power G is also connected to the building through a bidirectional meter 570 and through the inverter charger unit 530 can complete feeding the energy needs of the building.

FIG. 5A illustrates an example when the energy is exchanged between the grid G and the building based on the energy produced by the PV modules and the energy consumption of the building. FIG. 5B illustrates an example when most of the energy is delivered by the PV system. It is shown that through the bidirectional meter, the grid actually receives energy from the building in this case. In an example illustrated in FIG. 5C, most of the energy is delivered by the grid to the building. It is shown that through the bidirectional meter, the grid power is actually converted by the converter controller and afterwards reaches the breaker panel and feeds the appliances.

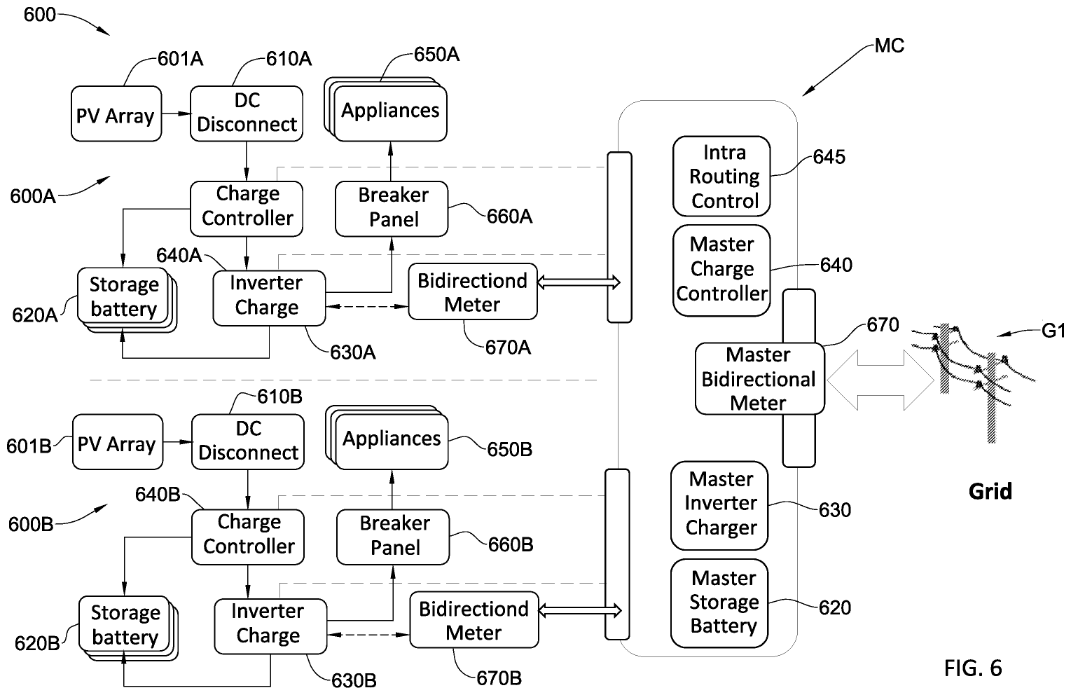

It is to be understood herein that a building may have several roof areas and, in some examples, the energy produced by the roof areas is to be shared by several apartments/houses located in that designated building. In some other examples, several houses or buildings construct a single complex entity (complex apartment housing) and their roof areas could be effectively shared among all the residents of the entity. In such cases, distribution and control of energy produced by the roof PV modules between the houses becomes challenging. The presently disclosed subject matter provides an energy distribution system addressing the roof areas as a common resource for energy production. FIG. 6 illustrates a simplified scenario two roof areas, whereas it is to be understood more than two roof areas can be common and the energy distribution system 600 can be implemented in scenario having N number of roof areas.

It is to be further understood that each of the roof areas can be a roof as described above with reference to FIGS. 3A-F and can have a sub-system similar to the one described above with reference to FIGS. 5A5C. Each system has a PV array which eventually its energy is converted, used, stored and mixed with the energy coming from an external network (grid). It is acknowledged that in cases with more than one roof per building, the system components do not need to be completely duplicated as some local aggregation can simplify the network architecture. However, for simplicity we assume the case of one system per building (or roof). Therefore, the energy distribution system 600, in the illustrated example being a solar-electrical energy distribution system 600, includes a first PV sub-system 600A and a second PV sub-system 600B, each of which represents a house and is similar to the energy distribution system 500 and include corresponding components and features.

The first and the second subsystems 600A and 600B include their respective first and second PV arrays 601A and 601B, each configured to produce electrical energy, first and second DC connect (relay) systems 610A and 610B, first and second storage batteries 620A and 620B, first and second inverter/converter charger 630A and 630B, first and second charge controllers 640A and 640B, first and second energy consuming units 650A and 650B, first and second breaker panels 660A and 660B, and first and second bi-directional meters 670A and 670B. Each of the components being configured to perform the corresponding functions as described with respect to system 500.

The sub-systems 600A and 600B are not connected directly with the national grid G. The system 600 includes a master controller MC configured to act as a mediating network between the national grid G and the houses (or apartments) sub-systems 600A and 600B. The master controller MC communicates with each charge controller 640A and 640B and inverter charger 630A and 630B of each sub-system 600A and 600B through a master charge controller 640 and a master inverter charger 630. By doing so, the exact energy production, storage and consumption by each of the sub-systems 600A and 600B are sensed by the master controller MC. The decisions to route energy excess from a specific house to the national grid and vice versa is driven by the master controller MC via an intra routing control unit 645. In addition, the master controller MC can route energy excess to other houses in need instead of routing it to the grid via its bidirectional meter 670. In some examples, local energy storage in the storage batteries 620 at the master controller MC can take place by routing part of the energy excess to the local energy storage.

In the illustrated example, the first and second charge controllers 640A and 640B control the distribution of energy produces by their respective PV arrays 601A and 601B and route the energy to their respective consumer units 650A and 650B. Each of the first and second charge controllers 640A and 640B route their respective excess energy to the master controller MC via the respective bi-directional meters 670A and 670B. In case, any of the charge controller 640A and 640B determine that the total amount of energy produced by their respective PV array is lesser than the energy required by the corresponding consumer units, that charge controller report an energy deficit to the master controller MC. The master controller MC takes a decision on whether to route energy to any of the two sub-systems 600A and 600B based on the energy excess and/or energy deficit reported by them, or to route the energy to the external grid G. In case, all the sub-systems report energy deficit, the master controller MC receives energy from the grid G and route to the sub-systems.

It is to be understood herein that the master controller can represent one building (including two or more houses) and can be configured to communicate and exchange energy between respective master controllers of other buildings under the supervision of a higher-level controller.

By controlling the energy distribution on such a level, some other use cases are facilitated. For example, pricing arrangements with the national grid can leverage the total available power of the buildings in total, as a common pool. Internal consumption patterns could be modified and incentivized by tightly coupling energy production utilization and cost. Households can share ownership of the infrastructure (e.g., selling energy to the grid) either using contractual agreements or virtual coin-based arrangements.

The present disclosure further provides a kit comprising one or more roof modules in accordance with any of the roof modules described herein according to various examples, and one or more anchor modules in accordance with any of the anchor modules described herein according to various examples. The kit includes the modules prefabricated in the factory that can be utilized to construct a roof of a building as described above. The kit further includes two or more charge controllers, each being identical to the charge controllers 600A and 600B described above. The kit further includes one or more master charge controller being identical to the master controller MC described above. The kit facilitates construction of a modular roof according to any of the examples described above and controlling energy distribution thereof according to any of the examples described above for energy distribution systems.

The present disclosure further provides a kit comprising one or more roof modules capable of producing electrical energy. The roof modules can include one or more features of the roof modules described herein above. The kit further includes two charge controllers, each being identical to the charge controllers 600A and 600B described above and configured to control energy distribution of the energy produced by the respective roof modules. The kit further includes a master charge controller being identical to the master controller MC described above and configured to control the energy distribution between the charge controllers and an external grid. The kit facilitates establishment of a modular roof according to any of the examples described above and controlling energy distribution thereof according to any of the examples described above for energy distribution systems.

The present disclosure further provides a method for solar-electrical energy distribution. The method includes providing the solar-electrical energy distribution system according to any one of the examples described above with respect to energy distribution systems. The method further includes receiving, by the first charge controller, the electrical energy produced by the first PV array, distributing, by the first charge controller, of the electrical energy produced by the first PV array to the one or more first energy consuming units based on the amount of energy produced by the first PV array and amount of energy required by the one or more first energy consuming units, routing, by the first charge controller, a corresponding energy excess to the master charge controller or reporting, by the first charge controller, a corresponding energy deficit to the master charge controller, receiving, by the second charge controller, the electrical energy produced by the second PV array, distributing, by the second charge controller, of the electrical energy produced by the second PV array to the one or more second energy consuming units based on the amount of energy produced by the second PV array and amount of energy required by the one or more second energy consuming units, routing, by the second charge controller, a corresponding energy excess to the master charge controller or reporting, by the second charge controller, a corresponding energy deficit to the master charge controller, receiving, by the master charge controller, respective energy excess and/or energy deficit requests from the first and second charge controllers, distributing electrical energy between the first and second charge controllers and an external grid based on the received respective energy excess and/or energy deficit requests.

1. A roof module inter-connectable with at least one other like-modules to form a roof of a building, said roof module comprising:
a structural frame having a first couplable zone and a second couplable zone, said first couplable zone being readily couplable to a respective second couplable zone of a respective like-module;
a Photo Voltaic (PV) layer connected to said structural frame at least partially between said couplable zones;
a first connection element disposed at said first couplable zone and operatively connected to said PV layer;
a second connection element disposed at said second couplable zone and operatively connected to said PV layer;
said first connection element being operatively couplable with a respective second connection element of the respective like-module to facilitate an electrical connection between their respective PV layers.

2. The roof module of claim 1, further comprising a functional layer associated with the roof including at least one of water insulation, thermal insulation, acoustic insulation, fire insulation, withstanding seismic lateral forces, drainage, and providing protection to an interior of the building from conditions including sunshine, rain, snow, sleet, hail, and/or winds.

3. The roof module of claim 1, wherein said roof module is inter-connectable with said respective like-module in a liquid sealable manner.

4. The roof module of claim 1, wherein the roof module comprises a front surface configured to face an exterior of the building, and opposite back surface configured to face an interior of the building, and a plurality of side surfaces extending between the front and back surfaces.

5. The roof module of claim 4, wherein a first side surface of the plurality of side surfaces at least partially includes said first couplable zone and a second side surface of the plurality of side surfaces at least partially includes said second couplable zone.

6-7. (canceled)

8. The roof module of claim 5, wherein at least one of the first side surface and the second surface has a stepped profile when seen in a cross-section taken along a plane perpendicular to the respective side surface as well as to the first and/or second surface.

9. The roof module of claim 8, wherein the stepped profile is inter-lockable with a respective stepped profile of the respective like-module to provide said inter-connection between the two modules.

10. The roof module of claim 5, wherein at least one of the first side surface and the second surface has an inclined profile when seen in a cross-section taken along a plane perpendicular to the respective side surface as well as to the first and/or second surface.

11. The roof module of claim 10, wherein the inclined profile is inter-lockable with a respective inclined profile of the respective like-module to provide said inter-connection between the two modules.

12. The roof module of claim 4, wherein the roof module is inter-connectable to the respective like-module such that at least a portion of the front surface of the roof module overlaps at least a portion of a respective second surface of the respective like-module in a direction perpendicular to a direction of said inter-connection and/or at least a portion of a respective front surface of the respective like-module overlaps at least a portion of the back surface of the roof module in a direction perpendicular to a direction of said inter-connection.

13. The roof module of claim 5, wherein the front surface is configured to constitute a continuous roof surface with a respective front surface of the respective like-module when the modules are inter-connected to form the roof.

14. The roof module of claim 1, wherein at least one of the first and second connection elements is configured to facilitate establishment of a continuous and sealed plumbing line therethrough.

15. (canceled)

16. The roof module of claim 1, wherein at least one of the first and second connection elements constitutes an electrical connector electrically coupled to the PV layer.

17-18. (canceled)

19. The roof module of claim 4, wherein the back surface is free of electrical or plumbing connections with an interior of the building.

20. The roof module of claim 1, wherein the connection elements are concealed by the couplable zones when the roof module is inter-connected with the respective like-module.

21. The roof module of claim 1, wherein said second couplable zone is readily couplable to a respective first couplable zone of another respective like-module.

22. The roof module of claim 1, wherein said second connection element is operatively couplable with a respective first connection element of said other respective like-module to facilitate an electrical connection between their respective PV layers.

23. The roof module of claim 1, wherein the structural frame comprises a third couplable zone and a fourth couplable zone, said third couplable zone being readily couplable to a respective fourth couplable zone of one of said at least one like-module and said fourth couplable zone being readily couplable to a respective third couplable zone of one of said at least one like-module.

24-47. (canceled)

48. A solar-electrical energy distribution system comprising:
a first Photo Voltaic (PV) sub-system comprising:
a first PV array configured for producing electrical energy from solar energy;
one or more first energy consuming units configured to consume electrical energy; and
a first charge controller operatively coupled to the first PV array and to the one or more first energy consuming units, and configured for controlling energy distribution to the one or more first energy consuming units;
a second Photo Voltaic (PV) sub-system comprising:
a second PV array configured for producing electrical energy from solar energy;
one or more second energy consuming units configured to consume electrical energy; and
a second charge controller operatively coupled to the second PV array and to the one or more second energy consuming units, and configured for controlling energy distribution to the one or more second energy consuming units; and
a master charge controller operatively coupled to the first and second charge controllers, said master charge controller being configured to exchange electrical energy produced by at least one of the first and second PV arrays with each of the first and second charge controllers and to control energy distribution between the first and second charge controllers and an external grid.

49-56. (canceled)

57. A kit comprising:
at least one first PV roof module inter-connectable with at least one other like-module to form a roof of a building, said first PV roof module being configured for producing electrical energy from solar energy;
a first charge controller configured for operatively coupling to the first PV roof module and controlling distribution of electrical energy produced by the first roof module to one or more first energy consuming units;
at least one second PV roof module inter-connectable with at least one other like-module to form a roof of a building, said second PV roof module being configured for producing electrical energy from solar energy;
a second charge controller configured for operatively coupling to the second PV roof module and controlling distribution of electrical energy produced by the second roof module to one or more second energy consuming units; and
a master charge controller configured for operatively coupling to the first and second charge controllers to exchange electrical energy with each of the first and second charge controllers and to control energy distribution between the first and second charge controllers and an external grid.

58-60. (canceled)
